(19) United States
(12) Patent Application Publication
(10) Pub. No.: US 2009/0150407 A1
(43) Pub. Date: Jun. 11, 2009

(54) SYSTEM AND METHOD FOR DOWNLOADING A FILE TO A WIRELESS DEVICE

(75) Inventors: CHUNG-I LEE, Tu-Cheng (TW); CHIU-HUA LU, Tu-Cheng (TW); ZHE-XIN LIU, Shenzhen City (CN); DA-BO CHANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/202,347

(22) Filed: Sep. 1, 2008

(30) Foreign Application Priority Data
Dec. 11, 2007 (CN) 200710202979.0

(51) Int. Cl. G06F 17/30

(52) U.S. Cl. 707/10; 707/E17.032

(57) ABSTRACT

An application server for downloading a file to a wireless device through a wireless network. The application server is configured for obtaining a file to be downloaded to the wireless device from a database, configured for converting the file obtained to a predetermined format file as required by the wireless device, and configured for sending the converted file to the wireless device through the wireless network.

### BACKGROUND

1. Field of the Invention

Embodiments of the present disclosure relate to systems and methods for processing a file, and more particularly to a system and method for downloading a file to a wireless device.

2. Description of Related Art

Different wireless devices, such as a mobile phone may support different file formats. Many problems may arise because of incompatible file formats. A mobile device may not be able to view a particular formatted file upon receiving the file. Accordingly, this creates frustrations for a user of the mobile device.

Accordingly, what is needed is a system and method for amending the above-mentioned deficiencies.

### SUMMARY

An application server for downloading a file to a wireless device through a wireless network in accordance with an exemplary embodiment is provided. The application server includes a receiving module, an obtaining module, a determining module, a converting module, and a sending module. The receiving module is configured for receiving a packet comprising instructions for downloading a selected file from a database to the wireless device through the wireless network. The obtaining module is configured for obtaining the selected file from the database according to the instructions. The determining module is configured for determining if the format of the selected file is in a first format required by the wireless device. The converting module is configured for converting the selected file into the first format if the format of the selected file is not in the first format. The sending module is configured for sending the converted file in the first format to the wireless device through the wireless network.

Other systems, methods, features, and advantages will be or become apparent to one skilled in the art upon examination of the following drawings and detailed description.

### BRIEF DESCRIPTION OF THE DRAWINGS

FIG. 1 is a schematic diagram of one embodiment of a system for downloading a file to a wireless device;

FIG. 2 is a block diagram of the application server including function modules;

FIG. 3 is a flowchart of one embodiment of a method for downloading a file to a wireless device.

### DETAILED DESCRIPTION OF CERTAIN INVENTIVE EMBODIMENTS

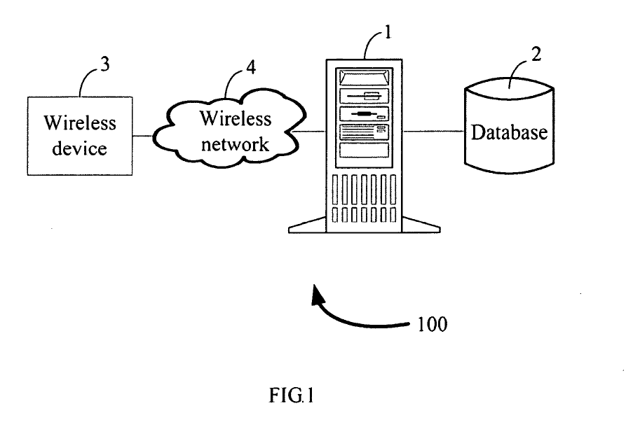

FIG. 1 is a block diagram of one embodiment of a system 100 for downloading a file to a wireless device 3. In one embodiment, the system 100 includes an application server 1, a database 2, and the wireless device 3. The database 2 connects with the application server 1, and is configured for storing files with different file formats/extensions, such as JPG format, TIFF format, DOC format, PDF, GIF format, and TXT format, for example. The wireless device 3 communicates with the application server 1 via a wireless network 4, and is configured for downloading a selected file from the database 2 via the application server 1. The application server 1 is configured for obtaining the selected file from the database 2, and converting the selected file to a predetermined format file as required by the wireless device 3. The application server 1 then is configured for sending the converted file to the wireless device 3 through the wireless network 4. The wireless device 3 may then view the converted file on a display of the wireless device 3.

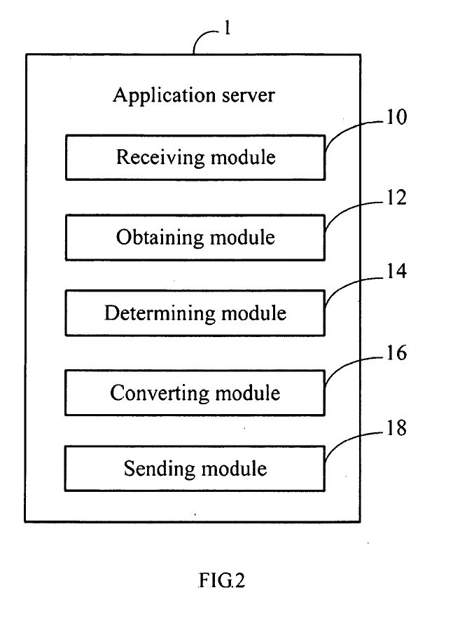

FIG. 2 is a block diagram of the application server 1 including function modules. In one embodiment, the application server 1 includes a receiving module 10, an obtaining module 12, a determining module 14, a converting module 16, and a sending module 18. The modules 10, 12, 14, 16, 18 may be used to execute one or more operations for the application server 1.

The receiving module 10 is configured for receiving a packet from the wireless device. The packet includes instructions for downloading a selected file from the database 2 to the wireless device 3 via the wireless network 4. In one embodiment, the instructions includes a filename of the file to be downloaded from the database 2. It may be understood that the file to be downloaded from the database includes a file type, such as DOC or JPG as mentioned above.

The obtaining module 12 is configured for obtaining the file to be downloaded from the database 2 according to the instructions.

The determining module 14 is configured for determining a file type for the downloaded file. The determining module 14 is further configured for determining if the downloaded file can be opened by the wireless device 3. As mentioned above, the wireless device 3 may be incompatible with one or more file formats and thus, the wireless device 3 may not be able to view one or more file formats. In one exemplary embodiment, the wireless device 3 may be only capable of opening files of JPG format. Thus, if the database 2 includes files of other formats, a file conversion must be made between various file formats such that the wireless device 3 can view the formatted files. One exemplary embodiment of the application server 3 converting files from other file formats to JPG file types (e.g., the file format that the wireless device 3 can view, in one embodiment) is illustrated below.

If a file, having a particular file format, can not be directly converted to a JPG format file, the particular format file must be converted to an interim format file that can be directly converted to a JPG format file. One exemplary embodiment of the present disclosure comprises formatting DOC formatted files into JPG files. However, it may be understood that the below-mentioned steps may apply to file formats other than that of JPG or DOC.

The determining module 14 is also configured for determining if the file selected is a DOC formatted file, if the file is not a JPG formatted file.

The converting module 16 is configured for converting the file to a postscript (PS) formatted file if the file is a DOC formatted file, and for converting the file to a JPG formatted file if the file is not a DOC formatted file.

The converting module 16 is also configured for converting the PS formatted file converted by the converting module 16 to a PDF file.

The converting module 16 is further configured for converting the PDF file converted by the converting module 16 to the JPG formatted file.

The sending module 18 is configured for sending the JPG formatted file to the wireless device 3 through the wireless network 4.

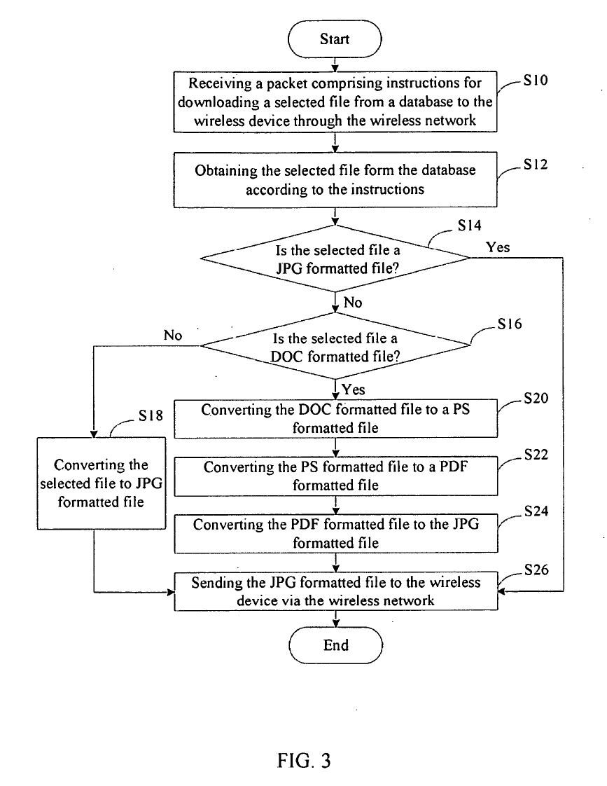

FIG. 3 is a flowchart of one embodiment of a method for downloading a file to a wireless device in accordance with the present disclosure.

In block S10, the receiving module 10 receives a packet including instructions to download a selected file from the database 2 to the wireless device 3 through the wireless network 4. As mentioned above, the instruction includes a filename of the file to be downloaded from the database 2.

In block S12, the obtaining module 12 obtains the file from the database 2 according to the instructions.

In block S14, the determining module 14 determines if the file is a JPG formatted file.

If the file is a JPG formatted file, then the procedure goes directly to block S26 described below. Otherwise, if the file is not a JPG formatted file, in block S16, the determining module 14 determines if the file is a DOC formatted file.

If the file is not a DOC formatted file, in block S18, the converting module 16 converts the file to a JPG formatted file, then the procedure goes directly to block S26 described below. Otherwise, if the file is a DOC formatted file, in block S20, the converting module 16 converts the file to a PS formatted file.

In block S22, the converting module 16 converts the PS formatted file converted by the converting module 16 to a PDF formatted file.

In block S24, the converting module 16 converts the PDF formatted file converted by the converting module 16 to a JPG formatted file.

In block S26, the sending module 18 sends the JPG formatted file to the wireless device 3 via the wireless network 4.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described embodiment(s) without departing substantially from the spirit and principles of the present disclosure. All such modifications and variations are intended to be included herein within the scope of this disclosure and the above-described embodiment(s) and protected by the following claims.

What is claimed is:

1. An application server for downloading a file to a wireless device through a wireless network, the application server comprising:
a receiving module configured for receiving a packet comprising instructions for downloading a selected file from a database to the wireless device through the wireless network;
an obtaining module configured for obtaining the selected file from the database according to the instructions;
a determining module configured for determining if the format of the selected file is in a first format required by the wireless device;
a converting module configured for converting the selected file into the first format if the format of the selected file is not in the first format; and
a sending module configured for sending the converted file in the first format to the wireless device through the wireless network.

2. The application server as claimed in claim 1, wherein the instructions comprises a filename of the selected file to be downloaded from the database.

3. The application server as claimed in claim 1, wherein the database comprises a plurality of files in the JPG format, TIF format, DOC format, PDF format, GIF format, postscript (PS) format, and TXT format.

4. A computer-implemented method for downloading a file to a wireless device via a wireless network, the method comprising:
receiving a packet comprising instructions for downloading a selected file from a database to the wireless device through the wireless network;
obtaining the selected file from the database according to the instructions;
determining if the format of the selected file is in a first format required by the wireless device;
converting the selected file into the first format upon the condition that the format of the selected file is not in the first format; and
sending the converted file in the first format to the wireless device through the wireless network.

5. The method as claimed in claim 4, wherein the instructions comprises a filename of the selected file to be downloaded from the database.

6. The system as claimed in claim 4, wherein the database comprises a plurality of files in the JPG format, TIF format, DOC format, PDF format, GIF format, postscript (PS) format, and TXT format.

7. A computer-readable medium having stored thereon programs for downloading a file to a wireless device, when executed by an application server, cause the application server to:
receive a packet comprising instructions for downloading a selected file from a database to the wireless device through the wireless network;
obtain the selected file from the database according to the instructions;
determine if the format of the selected file is in a first format required by the wireless device;
convert the selected file into the first format upon the condition that the format of the selected file is not in the first format; and
send the converted file in the first format to the wireless device through the wireless network.
